(19) United States
(12) Patent Application Publication
(10) Pub. No.: US 2009/0114891 A1
(43) Pub. Date: May 7, 2009

(54) Nail Pulling Device

(76) Inventor: Shane W. Metz, Dike, IA (US)

Correspondence Address: PATWRITE LLC, 408 W. MAIN ST., MARSHALLTOWN, IA, 50158-5759, US

(21) Appl. No.: 12/260,977

(22) Filed: Oct. 29, 2008

Related U.S. Application Data
(60) Provisional application No. 60/983,288, filed on Oct. 29, 2007.

(51) Int. Cl. B25C 11/00

(52) U.S. Cl. 254/25; 254/21

(57) ABSTRACT

A nail removing device comprises a handle portion connecting a claw portion distally disposed therein and a shank attachment shaft disposed on an opposite side of the claw portion. The shank attachment shaft fits in a standard pneumatic tool such as an air chisel or hammer is angled to provide vibratory and impact action to the claw portion. In use the claw portion is placed next to the nail to be removed and the air tool is activated. Pressure is applied generally parallel to the surface of the material holding the nail and the combination of the action of the air tool and the leverage provided by rotating the handle portion allows the user to easily and quickly remove the nail from the material with minimal effort. Other embodiments include hydraulic or mechanical impact source in place of a pneumatic one.

### RELATED APPLICATIONS

This application claims priority and herein incorporates by reference U.S. provisional patent application 60/983,288, filed Oct. 29, 2007.

### BACKGROUND OF THE INVENTION

As soon as builders put together the first structure, someone had to take it apart. Nails appear at least as early as the Roman times and greatly advanced the art of putting together wooden structures. Nails were originally made by hand by blacksmiths and generally included a head portion which could be used to remove them at a later time by applying upward pressure. Of course now almost all nails are made by machine, but most still include a head portion to facilitate their holding power and to aid in their removal.

To remove a nail from a material, a lever, such as a crow bar or hammer claw, is generally applied under the head of the nail and then and upward pressure is generated as the crow bar or claw is rotated around its fulcrum point to force the nail from the material. Sometimes, especially when working with older structures, the heads of the nails become embedded in the surface making the removal process laborious and difficult. Many devices have been invented to aid in this process but removing fasteners has remained a labor intensive activity, especially when the fasteners are deeply embedded in a material. There is a need for an easy to use device and method of removing fasteners that allows a user to efficiently and with minimum effort remove even deeply embedded fasteners.

### SUMMARY OF THE INVENTION

A nail removing device comprises a handle portion connecting a claw portion distally disposed therein and a shank attachment shaft disposed on an opposite side of the claw portion. The shank attachment shaft fits in a standard pneumatic tool such as an air chisel or hammer is angled to provide vibratory and impact action to the claw portion. In use the claw portion is placed next to the nail to be removed and the air tool is activated. Pressure is applied generally parallel to the surface of the material holding the nail and the combination of the action of the air tool and the leverage provided by rotating the handle portion allows the user to easily and quickly remove the nail from the material with minimal effort. Other embodiments include hydraulic or mechanical impact source in place of a pneumatic one.

Other features and advantages of the instant invention will become apparent from the following description of the invention which refers to the accompanying drawings.

### BRIEF DESCRIPTION OF THE DRAWINGS

FIG. 1 is a side view of a nail pulling device according to an embodiment of the present invention.

FIG. 2 is a front view of the nail pulling device shown in FIG. 1.

FIG. 3 is a side view of an embodiment of a nail pulling device according to an embodiment of the present invention.

FIG. 4 is a front view of the nail pulling device shown in FIG. 3.

FIG. 5 is a front view of a nail pulling device according to an embodiment of the present invention.

FIG. 6 is a side view of a nail pulling device according to an embodiment of the present invention.

FIG. 7 is an illustration of a step in a method using a nail pulling device according to an embodiment of the present invention.

FIG. 8 is a side view of a step in a method of using a nail pulling device according to an embodiment of the present invention.

FIG. 9 is a side view of a step in a method of using a nail pulling device according to an embodiment of the present invention.

FIG. 10 is a side view of an embodiment of a nail pulling device according to an embodiment of the present invention.

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

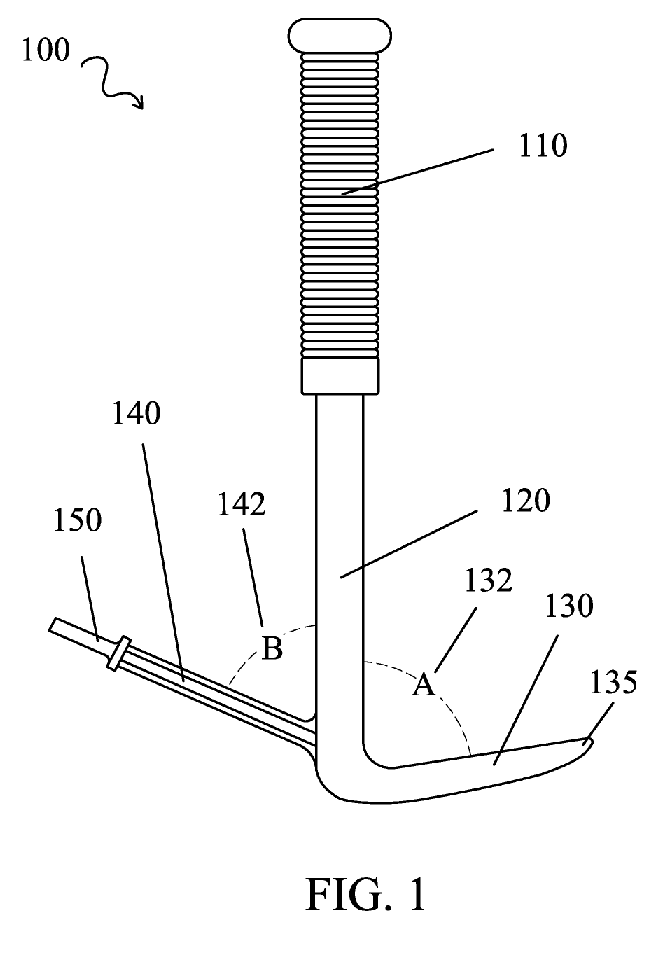

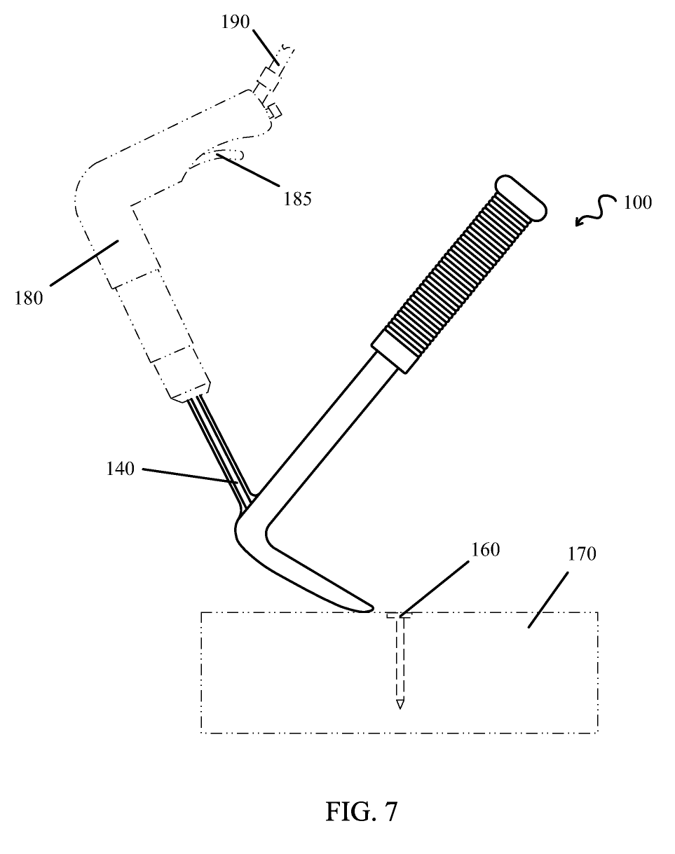

Referring to FIGS. 1, 2 and 7, a pneumatic nail pulling device 100 has a handle portion 110 which is made of an ergonomically friendly material such as rubber or plastic to cushion the grip and allow a user to hold device 100 without slipping. A shaft portion 120 is provided to allow leverage to be applied to a nail 160 by rotating around a claw portion 130. Claw portion 130 is disposed at an angle A 132 to shaft portion 120. Angle A 132 is generally between 90 degrees and 70 degrees, although other angles would be acceptable as long as a user applying a force to handle 110 is able to apply a non-parallel force to claw portion 130. Claw portion 130 includes a split portion 135 to engage with a head of nail 160. A shank shaft attachment portion 140 has a standard tool attachment fitting 150 as is common to air tools such as air hammers and chisels as is known in the art. A shank shaft angle B 142 is selected to be between 90 degrees to 45 degrees and allows a force applied along shank shaft 140 to be directed at least in part to said claw portion. Again, other angles are acceptable as long as some force applied to said shank shaft 140 is directed along claw portion 130. In use, shank shaft attachment portion 140 is inserted in an air tool 180 and the user holds device 100 by handle portion 110 and air tool 180 to position device 100 close to nail 160. Of course other devices may be used in place of an air tool such as electric or hydraulic impact devices as is known in the art.

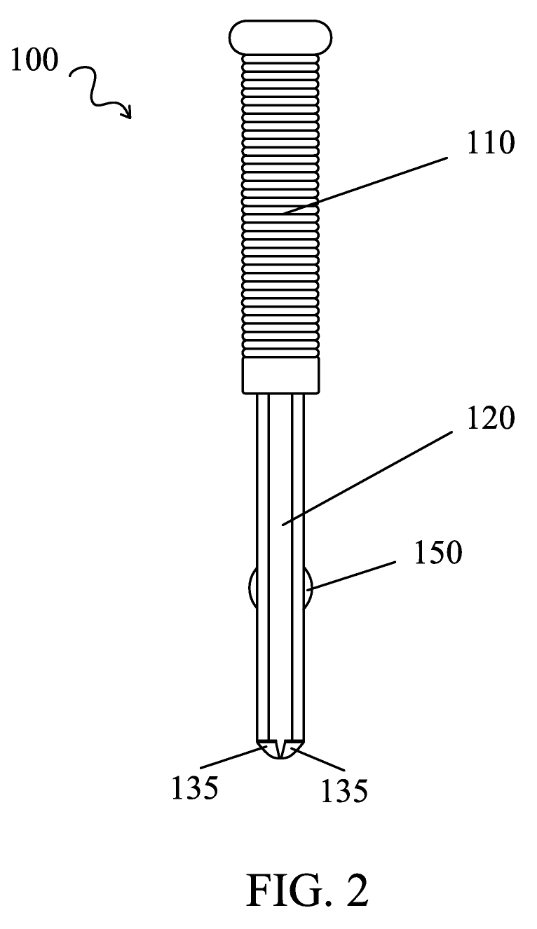

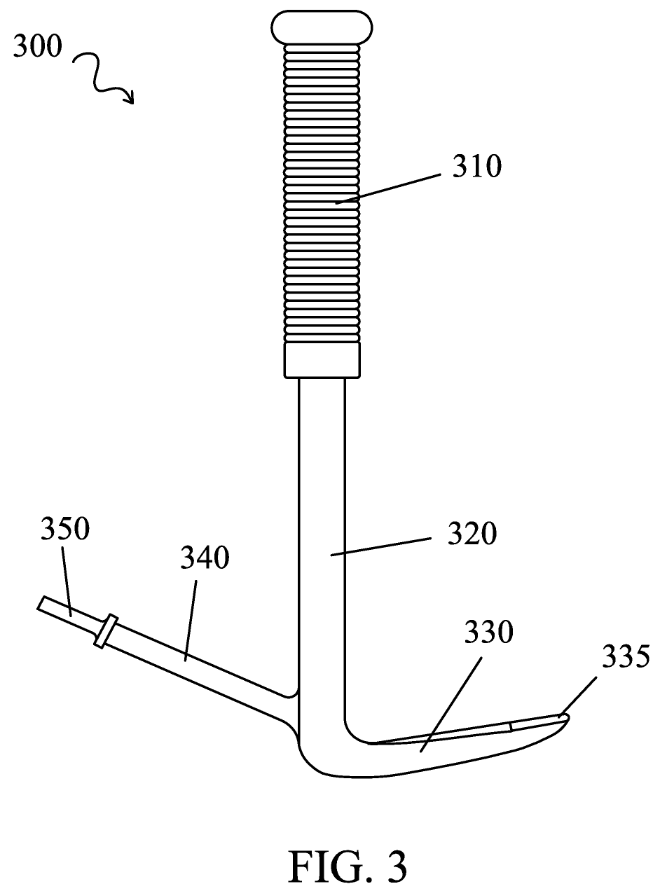

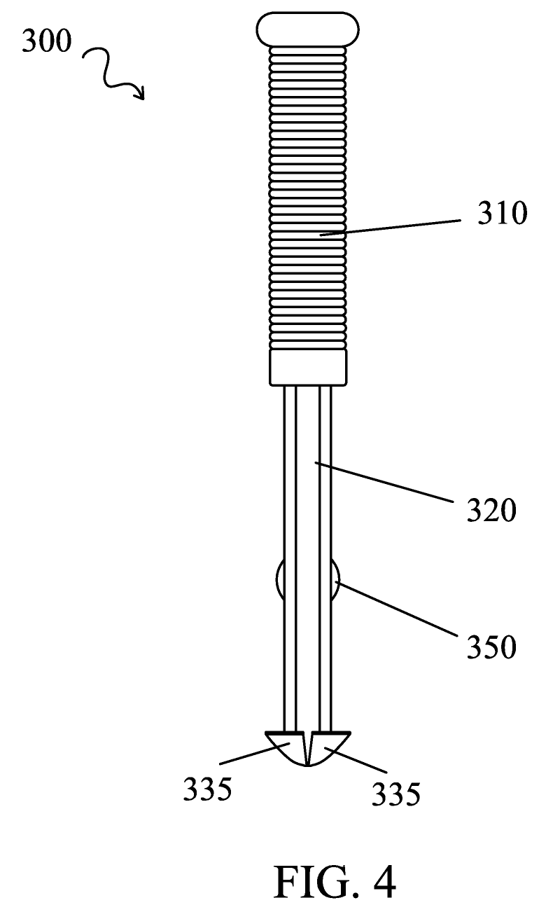

Referring to FIGS. 3 and 4, an embodiment of a pneumatic nail puller 300 is shown having a different geometry for claw portion 330. A handle portion 310, shaft portion 320, shank shaft attachment portion 340 and attachment fitting 350 operate in the same manner as discussed in respect to FIGS. 1 and 2. A split portion 335 has an enlarged engagement area.

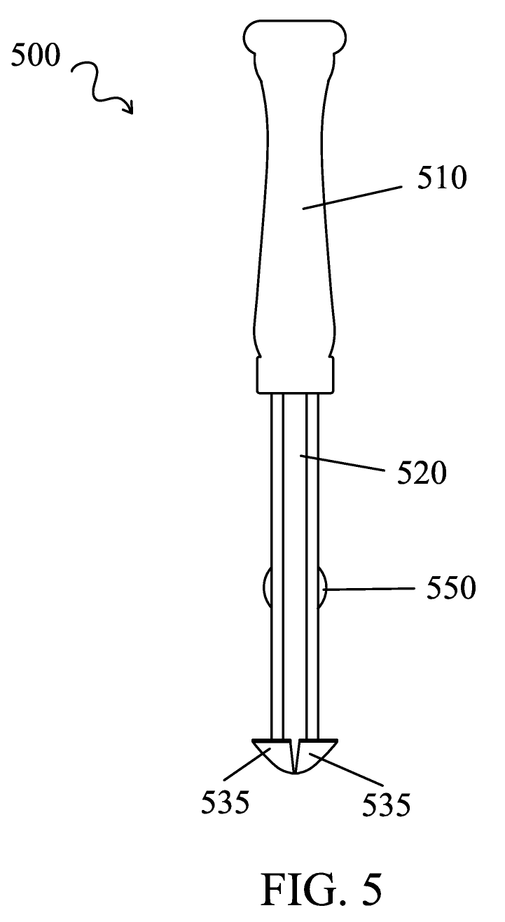

Now with reference to FIG. 5, a handle portion 510 has an alternative ergonomic shape to allow a user to control a nail remover 500. Again a shaft portion 520, a shaft attachment portion 550 and a split portion 535 are provided and function as discussed above.

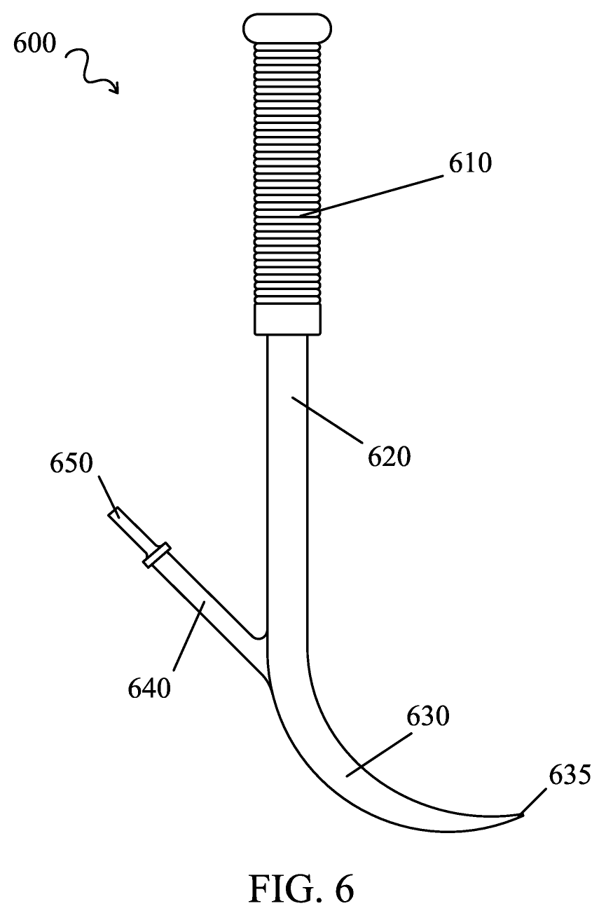

Referring to FIG. 6, a nail remover 600 is shown having an alternative claw portion 603 geometry to facilitate selected removing activities. As above, a handle portion 610, a shaft portion 620, a shank shaft attachment portion 640, and an attachment fitting portion 650 are provided and function as discussed above. A split portion 635 is also provided.

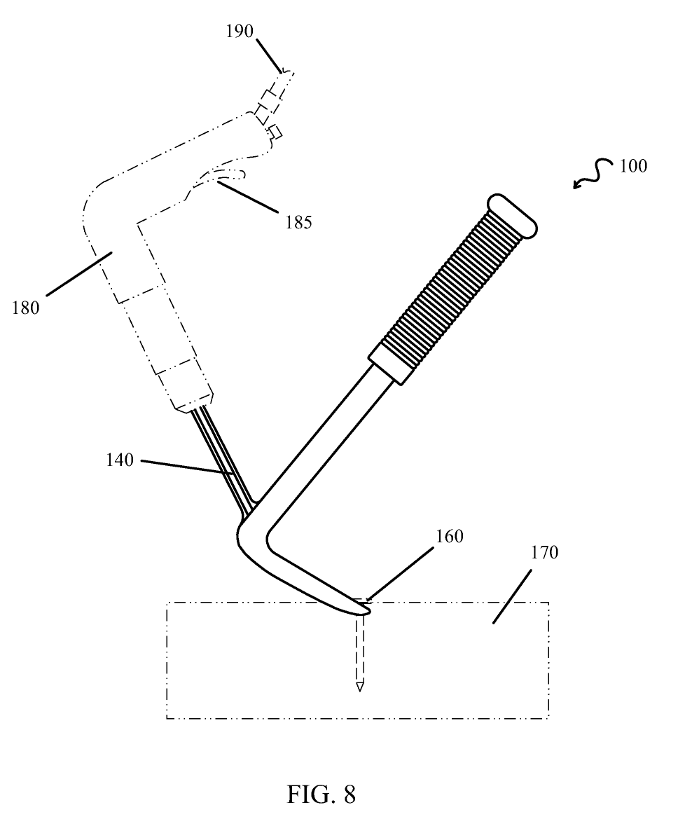

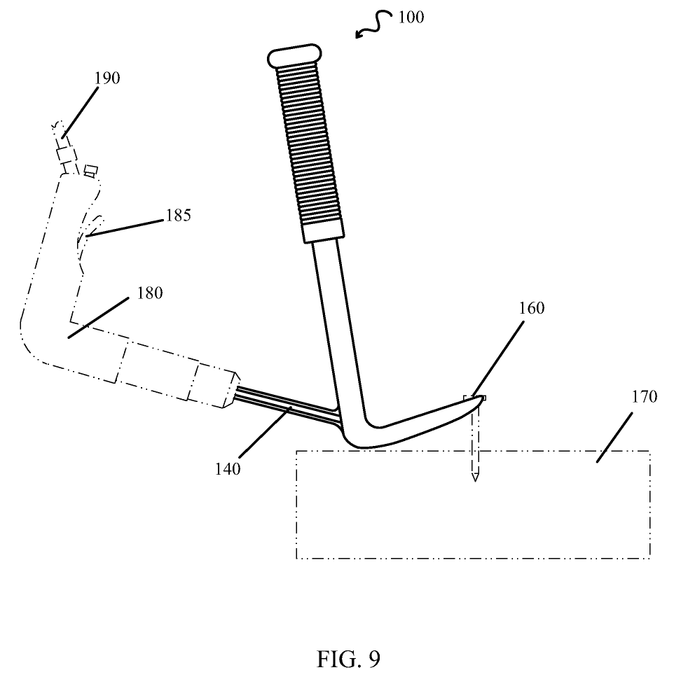

Now referring to FIGS. 1 and 7 through 9, pneumatic nail puller 100 is operated by placing nail puller 100 adjacent to nail 160 to be removed. The user holds and controls nail puller 100 by gripping handle portion 110 and air tool 180. The user pulls a trigger 185 which engages air tool 180. Air tool 180 is connected through an air hose 190 to an air source (not shown) to provide the hammering and vibratory action in operation.

As air tool 180 operates, split portion 135 slides under nail 160 when the user directs nail remover 100 towards nail 160 even when nail 160 is deeply embedded within a material 170. Nail 160 is removed as the user rotates nail remover 100 around claw portion 130 while operating air tool 180. Nails are removed with minimal effort and at a pace that is much faster than is possible using traditional methods.

As shown in the drawings, the precise geometry of the claw portion is not critical as many different geometries are suitable as long as an upward pressure is provided to force the nail upward out of the material. Additionally, the precise geometry of the split portion is not critical and even a slight indentation would be suitable to engage the head portion of a nail.

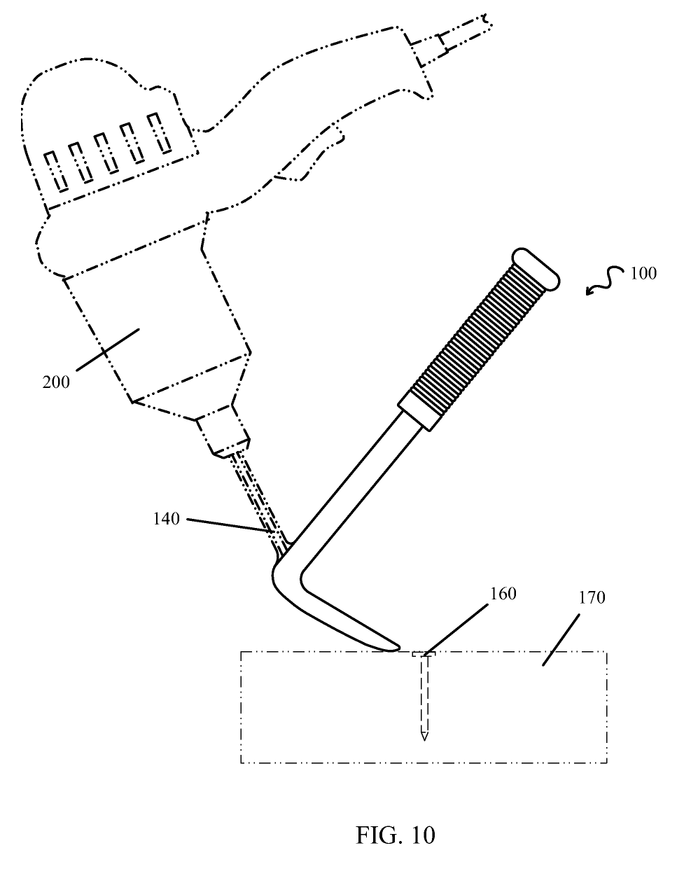

Referring now to FIG. 10, an electric impact tool 200 is shown attached to nail removing device 100. Other mechanical or hydraulic devices are suitable as long as they are capable of transmitting a vibratory motion to shank shaft attachment portion 140.

Although the instant invention has been described in relation to particular embodiments thereof, many other variations and modifications and other uses will become apparent to those skilled in the art.

What is claimed is:

1. A nail removing device comprising:
a shaft having a handle portion disposed on an end thereof;
a claw portion disposed at an end of said shaft;
a split portion distally disposed on said claw portion;
said claw portion being disposed at a claw angle with respect to said shaft;
a shank shaft attachment portion disposed on said shaft and opposedly disposed to said claw portion; and
said shank shaft attachment portion being attached to said shaft at a shank angle with respect to said shaft and aligned to transmit a force generally parallel to said claw portion.

2. The nail removing device according to claim 1 wherein said claw angle is between 90 degrees and 60 degrees.

3. The nail removing device according to claim 1 wherein said shaft, said claw portion and said shank shaft attachment portion are made from steel.

4. The nail removing device according to claim 1 wherein said handle portion is a resilient material.

5. The nail removing device according to claim 1 wherein said shank angle is selected to generally align with a plane defined by said claw portion.

6. The nail removing device according to claim 1 wherein said shank angle is between 90 degrees and 60 degrees.

7. The nail removing device according to claim 1 wherein said handle is rubber.

8. The nail removing device according to claim 1 wherein said handle is an energy absorbing material.

9. The nail removing device according to claim 1 wherein said shank shaft attachment portion is adapted to fit within an impact tool chuck.

10. The nail removing device according to claim 1 wherein said split portion has a leading edge adapted to cut into a surface.

11. The nail removing device according to claim 1 wherein said claw portion defines a curved section.

12. A nail pulling device comprising:
a shaft having a handle end and an opposite end;
a nail pulling lever portion disposed on said opposite end;
said nail pulling lever portion being disposed at a lever angle to said shaft;
a split portion distally disposed on an end of said nail pulling lever portion wherein a nail fits therein; and
a shank shaft attachment portion generally disposed opposite to said nail pulling lever portion and disposed at a shank shaft angle to said shaft.

13. The nail removing device according to claim 12 wherein said lever angle is between 90 degrees and 60 degrees.

14. The nail removing device according to claim 12 wherein said shaft, said nail pulling lever portion and said shank shaft attachment portion are made from steel.

15. The nail removing device according to claim 12 wherein said shank shaft angle is selected to generally align with a plane defined by said nail pulling lever portion.

16. The nail removing device according to claim 12 wherein said shank shaft angle is between 90 degrees and 60 degrees.

17. The nail removing device according to claim 12 further comprising a handle substantially covering said handle end.

18. The nail removing device according to claim 17 wherein said handle is an energy absorbing material.

19. The nail removing device according to claim 12 wherein said shank shaft attachment portion is adapted to fit within an impact tool chuck.

20. The nail removing device according to claim 12 wherein said split portion has a leading edge adapted to cut into a surface.
